(19) United States
(12) Patent Application Publication
(10) Pub. No.: US 2008/0238319 A1
(43) Pub. Date: Oct. 2, 2008

(54) Method for Forming Barrier Ribs of Plasma Display Panel

(76) Inventors: Tatsutoshi Kanae, Miyazaki (JP); Akihiro Fujinaga, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/065,307

(22) PCT Filed: Aug. 31, 2005
(86) PCT No.: PCT/JP2005/015922

§ 371 Date: Feb. 29, 2008

(51) Int. Cl. H01J 17/49; H01J 9/02

(52) U.S. Cl. 313/582; 445/24

(57) ABSTRACT

The present invention forms barrier ribs by using a glass sheet so that it becomes possible to reduce the cost of forming the barrier ribs, and to easily form the barrier ribs and electrodes. A dry film, which is fired to be formed into a dielectric layer, is formed on a substrate, a glass sheet having a thickness corresponding to a height of barrier ribs to be formed is secured onto the dry film, and a resist pattern corresponding to a shape of barrier ribs is formed on the glass sheet so that, by cutting off the glass sheet corresponding to unnecessary portions through sand blasting, the glass sheet is formed into the shape of barrier ribs, and the dry film is fired at a temperature lower than softening points of the substrate and the glass sheet so that the substrate and the glass sheet are anchored by the dielectric layer corresponding to the fired dry film; thus, the barrier ribs are formed.

### TECHNICAL FIELD

The present invention relates to a method for forming barrier ribs of a plasma display panel (PDP), and more particularly relates to a method for forming barrier ribs, which is mainly applied to a three-electrode surface-discharge-type PDP of an AC-drive type.

### BACKGROUND ART

A three-electrode surface-discharge-type PDP of an AC-drive type has been known as a conventional PDP. This PDP has a structure in which a number of display electrodes capable of surface discharging are formed on an inner face of one of substrates (for example, a substrate on the front face side or display face side) in a horizontal direction and a number of address electrodes for use in selecting light-emitting cells are formed on an inner face of the other substrate (for example, a substrate on the back face side) in a direction intersecting with the display electrodes so that each of intersections between the display electrodes and the address electrodes is designed to form one cell (unit light-emitting area). One pixel is configured by three cells, that is, a red (R) cell, a green (G) cell and a blue (B) cell.

The display electrodes on the substrate on the front face side are covered with a dielectric layer. The address electrodes on the substrate on the back face side are also covered with a dielectric layer, with a barrier rib being formed between the address electrodes, and each of phosphor layers for R, G and B is formed between barrier ribs separating respective areas corresponding to the R cell, G cell and B cell.

The PDP is manufactured by processes in which, with the substrate on the front face side and the substrate on the back face side, thus prepared, being aligned face to face with each other, the peripheral portion is sealed, and a discharge gas is then sealed inside thereof (see Unexamined Patent Publication JP2003-303542).

### DISCLOSURE OF THE INVENTION

### Problems to be Solved by the Invention

The following methods have been known as the method for forming barrier ribs for the PDP. In a first method, an electrode barrier layer (fired film of a dielectric material, or the like) is formed on a substrate, and a low-melting-point glass paste is applied thereto and dried thereon so that a barrier-rib material layer is formed; then, the barrier-rib material layer is cut off by sand blasting to form barrier ribs. In a second method, a glass substrate is directly cut off by sand blasting so that barrier ribs are formed.

Although it is suitable for mass-production, the first method has the following problems. That is, since half or more of the barrier-rib material is discarded, the manufacturing cost becomes higher. Moreover, since the dried film formed by sand blasting is fired, the end portions in the longitudinal direction of each barrier rib are deflected by firing contraction of the barrier rib to cause a gap toward the opposing substrate, resulting in generation of noise upon vibration of the panel. Furthermore, since the low-melting-point glass paste is used, foreign matters, etc. tend to be mingled into the paste, resulting in problems, such as chipping in the barrier rib and formation of concave sections in the barrier rib.

The second method has been developed progressively, since no low-melting-point glass paste serving as a barrier-rib material is required and a reduction in the material cost is subsequently expected. However, this method has the following problems. Since address electrodes are formed after the formation of the barrier ribs, it becomes difficult to form the address electrodes. In the case of forming a so-called box-shaped barrier rib having not only barrier ribs in a longitudinal direction, but also barrier ribs in a lateral direction, a through hole needs to be formed in each barrier rib in the lateral direction, or each address electrode needs to be formed in a manner so as to get over the barrier rib in the lateral direction; therefore, at present, it is very difficult to apply this method from the viewpoint of reliability.

The present invention, which has been devised to solve such problems, makes it possible to reduce a formation cost of barrier ribs by using a glass sheet to form the barrier ribs, and also to easily form the barrier ribs and electrodes.

### Means to Solve the Problems

The present invention provides a method for forming barrier ribs of a plasma display panel comprising the steps of: forming on a substrate a dry film which is fired to be formed into a dielectric layer; securing on the dry film a glass sheet having a thickness corresponding to a height of barrier ribs to be formed; forming a resist pattern corresponding to a shape of barrier ribs on the glass sheet so that, by cutting off the glass sheet corresponding to unnecessary portions through sand blasting, the glass sheet is formed into the shape of barrier ribs; and firing the dry film at a temperature lower than the softening points of the substrate and the glass sheet so that the substrate and the glass sheet are anchored by the dielectric layer corresponding to the fired dry film.

### EFFECTS OF THE INVENTION

In the present invention, since a glass sheet is used for barrier ribs, the barrier ribs are free from deflection and the like in each end portion thereof due to firing contraction in the barrier ribs so that it becomes possible to prevent occurrence of noise upon vibration of the panel. Moreover, since the glass sheet, as it is, forms the top portions of the barrier ribs, it is possible to obtain highly smoothed top portions of the barrier ribs, and consequently to easily maintain adhesion to the opposing substrate. Thus, crosstalk with adjacent cells hardly occurs, making it possible to obtain sufficient panel reliability. Since no low-melting-point glass paste is required, a great cost reduction is achieved. Even in a case where closed-type barrier ribs such as those of a box type are formed, electrodes can be easily formed because the electrodes are formed on the substrate prior to the formation of a dry film, thereby making it possible to solve the major conventional problem caused upon forming barrier ribs by directly cutting the substrate off.

### BRIEF DESCRIPTION OF THE DRAWINGS

FIG. 1(a) and FIG. 1(b) are explanatory views showing a structure of a PDP according to the present invention.

FIG. 2(a), FIG. 2(b), and FIG. 2(c) are explanatory views showing a method for forming barrier ribs.

FIG. 3(a) and FIG. 3(b) are explanatory views showing another method for forming barrier ribs.

### REFERENCE NUMERALS

10 PDP
11 Substrate on front face side
12 Transparent electrode
13 Bus electrode
17 Dielectric layer
18 Protective film
21 Substrate on back face side
24 Dielectric layer
28R, 28G, 28B Phosphor layer
29 Barrier rib
30 Discharge space
31 Dry film of dielectric layer
32 Glass sheet
33 Barrier rib pattern of dry film resist
A Address electrode
G Load
L Display line
X, Y Display electrode

### BEST MODE FOR CARRYING OUT THE INVENTION

In the present invention, first, a dry film to be formed into a dielectric layer is formed on a substrate. Examples of the substrate include a substrate made from glass, quartz, ceramics or the like, and a substrate on which desired components, such as electrodes, are formed on such a substrate.

The dry film that is formed into a dielectric layer can be formed through processes in which, for example, a low-melting-point glass paste is applied to a substrate by using a known method such as a screen-printing method and a paste-coating method and dried thereon. The low-melting-point glass paste may be formed by using various paste materials known in the corresponding field. In the present invention, the dry film is preferably formed by using a material in which a sufficient amount of resin capable of providing an adhesive property and sandblast resistance to the glass sheet after the drying process is contained.

Alternatively, the dry film may be formed through processes in which an adhesive sheet, preliminarily prepared by allowing the sheet to contain a sufficient amount of resin capable of providing an adhesive property and sandblast resistance to the glass sheet, is bonded to the substrate.

The dry film may be formed through processes in which an adhesive agent, prepared by allowing it to contain a sufficient amount of resin capable of providing an adhesive property and sandblast resistance to the glass sheet, is sprayed on the substrate. Thus, it is possible to allow the dry sheet to have a sufficient adhesive property to the glass sheet.

In the present invention, next, a glass sheet having a thickness corresponding to the height of barrier ribs to be desirably formed is secured onto the dry film. The glass sheet may be formed by using various materials known in the corresponding field, and applied. For example, borosilicate glass, soda lime glass generally used for window glass, or the like, may be used.

A colored glass sheet may be used as this glass sheet. Moreover, prior to the formation of a resist pattern onto a glass sheet, a process may be further prepared in which a black paste is applied onto the glass sheet and dried thereon.

In the present invention, next, a resist pattern corresponding to the shape of the barrier ribs is placed on the glass sheet, and by cutting off the unnecessary portions of the glass sheet using sandblast, the glass sheet is formed into the shape of the barrier ribs.

The resist pattern may be shaped into a resist pattern of barrier ribs through exposing and developing processes by using a photolithographic method by the use of a dry film resist, or the resist pattern of barrier ribs may be formed through processes in which a liquid-state resist is applied thereto, and after having been dried, the resulting pattern is subjected to exposing and developing processes.

In the present invention, next, by firing the dry film at a temperature under the softening points of the substrate and the glass sheet, the substrate and the glass sheet are anchored and secured to each other by a dielectric layer corresponding to the fired dry film. The firing process may be carried out by using a known firing furnace in the corresponding field.

Upon firing the dry film, another process may be prepared in which, by pressing the glass sheet onto the substrate, the adhesive property between the substrate and the glass sheet is further improved.

The following description will discuss the present invention in detail based upon embodiments with reference to drawings. Here, the present invention is not intended to be limited by these, and various modifications may be made therein.

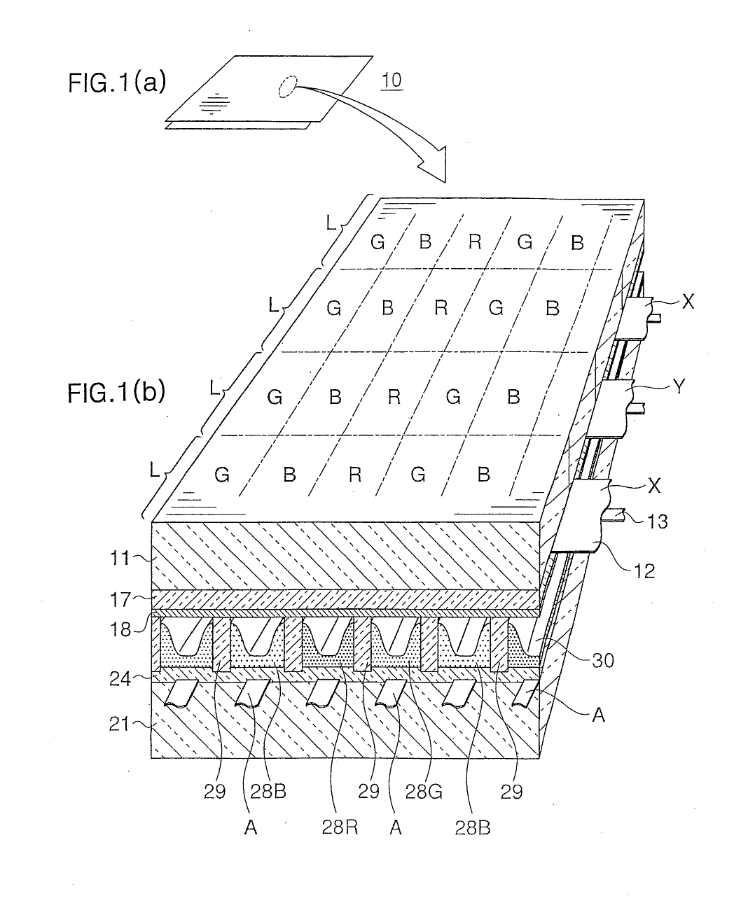

FIG. 1(a) and FIG. 1(b) are explanatory views showing a structure of a PDP according to the present invention. FIG. 1(a) is a general view, and FIG. 1(b) is a partially exploded perspective view thereof. This PDP is a surface-discharge type PDP with three electrodes of AC-drive type used for color display.

This PDP 10 is configured by a substrate 11 on a front face side and a substrate 21 on a back face side. For example, a glass substrate, a quartz substrate, a ceramic substrate or the like may be used as the substrate 11 on the front face side and the substrate 21 on the back face side.

On the inner face of the substrate 11 on the front face side, display electrodes X and display electrodes Y are placed in a horizontal direction with equal intervals. Each of gaps between adjacent display electrodes X and display electrodes Y forms a display line L. Each of the display electrodes X and Y is configured by a transparent electrode 12, having a wide width, made from ITO, SnO₂ or the like, and a bus electrode 13, having a narrow width, made of metal, such as Ag, Au, Al, Cu, and Cr, and a laminated body thereof (for example, a laminated structure of Cr/Cu/Cr). Upon forming these display electrodes X and Y, a thick-film-forming technique such as a screen-printing process is used for Ag and Au, and a thin-film-forming technique, such as a vapor deposition method and a sputtering method, and an etching technique are used for the other materials so that a desired number of electrodes having desired thickness, width and gap can be formed.

Here, in the present PDP, a PDP having a so-called ALIS structure in which display electrodes X and display electrodes Y are placed with equal intervals, with each gap between the adjacent display electrode X and display electrode Y being allowed to form a display line L, has been exemplified; however, the method for forming barrier ribs of the present invention may also be applied to a PDP having a structure in which paired display electrodes X and Y are placed separately with a distance (non-discharge gap) in which the paired display electrodes X and Y generate no discharge.

On the display electrodes X and Y, an alternating-current (AC) driving dielectric layer 17 is formed in a manner so as to cover the display electrodes X and Y. The dielectric layer 17 is formed by processes in which a low-melting-point glass paste is applied onto a substrate 11 on the front face side by using a screen-printing method and fired thereon. The dielectric layer 17 may also be formed by film-forming a SiO₂ film thereon by using a plasma CVD method.

A protective film 18, used for protecting the dielectric film 17 from damage due to collision of ions generated by discharge upon display, is formed on the dielectric layer 17. This protective film is made from MgO or the like. The protective film may be formed by using a known thin-film forming process in the corresponding field, such as an electron beam vapor deposition method and a sputtering method.

On the inner side face of the substrate 21 on the back face side, a plurality of address electrodes A are formed in a direction intersecting with the display electrodes X and Y as seen from the plan view, and a dielectric layer 24 is formed in a manner so as to cover the address electrodes A. The address electrodes A, which generate an address discharge used for selecting cells to emit light at intersections with the display electrodes Y, is formed into a three-layer structure of Cr/Cu/Cr. These address electrodes A may also be formed by using another material, such as Ag, Au, Al, Cu and Cr. In the same manner as in the display electrodes X and Y, upon forming these address electrodes A, a thick-film-forming technique such as a screen-printing process is used for Ag and Au, and a thin-film-forming technique, such as a vapor deposition method and a sputtering method, and an etching technique are used for the other materials so that a desired number of electrodes having desired thickness, width and gap can be formed. The dielectric layer 24 serves as an electrode barrier layer upon forming barrier ribs.

A plurality of barrier ribs 29 having a stripe shape are formed on the dielectric layer 24 between the adjacent address electrodes A. Not limited to this shape, the shape of the barrier ribs 29 may have a mesh shape (box shape) that divides the discharge space for each of the cells. The barrier ribs 29 are formed through a sand blasting method by using a glass sheet. The forming method of these barrier ribs will be described later.

On the dielectric layer 24, phosphor layers 28R, 28G and 28B corresponding to red (R), green (G) and blue (B) are formed on the side faces of the barrier ribs 29 and the gaps between the barrier ribs. The phosphor layers 28R, 28G and 28B are formed through processes in which a phosphor paste containing phosphor powder, a binder resin and a solvent is applied onto the inside a discharge space having a concave groove shape between the barrier ribs 29 by using a screen-printing method or a method using a dispenser, and after these processes have been repeated for each of the colors, a firing process is carried out. These phosphor layers 28R, 28G and 28B may also be formed by using a photolithographic technique through processes in which a sheet-shaped phosphor layer material (so-called green sheet) containing phosphor powder, a photosensitive material and a binder resin is used. In this case, a sheet having a desired color may be affixed onto the entire face of a display area on a substrate, and the sheet is subjected to exposing and developing processes; thus, by repeating these processes for each of the colors, the phosphor layers having the respective colors are formed in the corresponding gaps between the barrier ribs.

The PDP is manufactured through processes in which the substrate 11 on the front face side and the substrate 21 on the back face side are placed so as to face each other in a manner so as to allow the display electrodes X, Y and address electrodes A to intersect with each other, and the peripheral portion thereof is sealed with a discharge space 30 surrounded by barrier ribs 29 being filled with a discharge gas formed by mixing Xe and Ne. In this PDP, the discharge space 30 at each of intersections between the display electrodes X and Y and the address electrodes A forms one cell (unit light-emitting area) that is the minimum unit of display. One pixel is configured by three cells of R, G and B.

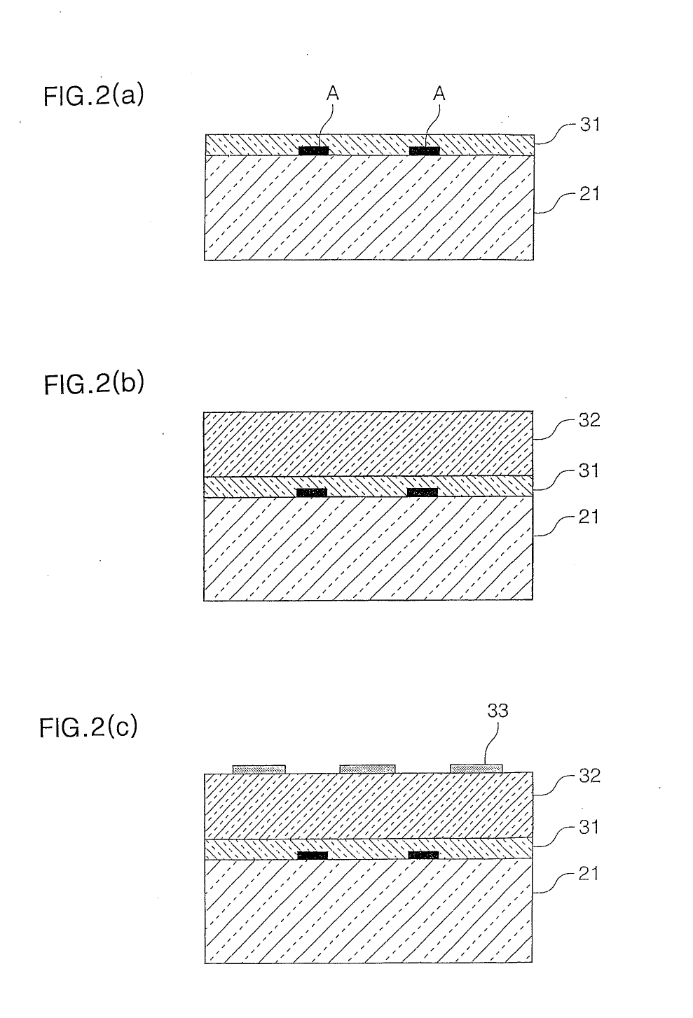

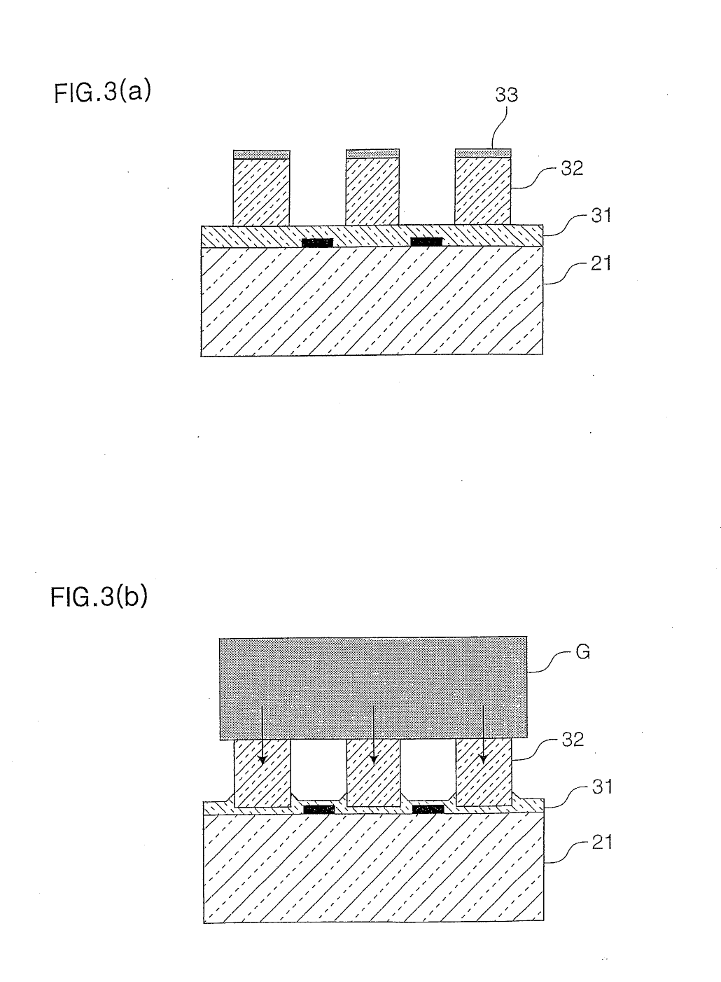

FIG. 2(a) to FIG. 2(c) and FIG. 3(a) and FIG. 3(b) are explanatory views showing a method for forming barrier ribs. The following description will discuss the method for forming barrier ribs of the present invention in the order of processes.

### Process for Forming a Dry Film

First, a dry film 31 is formed by using a dielectric material on the glass substrate 21 on the back face side on which address electrodes A are formed (see FIG. 2(a)). The address electrodes A have been formed by using a know material and a known method in the corresponding field. The dry film 31 of the dielectric material is formed through processes in which a low-melting-point glass paste is applied by using a screen-printing method, a paste-coating method or the like, and dried thereon. The low-melting-point glass paste is formed by adding a filler such as ceramics, a binder resin and a solvent to low-melting-point glass flit. The dry film 31 of the dielectric material may be formed by affixing a sheet-shaped material (referred to as green sheet or the like) thereto.

The dry film 31 of the dielectric material functions as an electrode barrier layer. That is, upon carrying out a sand blasting process, which will be described later, it stops the cutting process of the sand blast and consequently protects the address electrodes A. For this reason, the low-melting-point glass paste is allowed to contain a sufficient amount of resin so as to exert a sufficient viscoelastic property.

### Glass Sheet Securing Process

Next, a glass sheet 32 having a thickness corresponding to the desired height of barrier ribs is placed on the dry film 31 of the dielectric material, and secured thereon (see FIG. 2(b)). At this time, since the dry film 31 of the dielectric material has a sufficient adhesive property, the glass sheet 32 can be properly secured. The thickness of the glass sheet 32 is preferably set in a range from 50 to 500 μm.

### Resist-Film Forming Process

Next, a dry film resist is affixed onto the glass sheet 32, and this is subjected to exposing and developing processes through a desired photomask so that a barrier rib pattern 33 of the dry film resist is formed on the glass sheet 32 (see FIG. 2(c)). At this time, the pattern of the address electrodes A may be used as an alignment mark. That is, an alignment process, required at the time of printing (upon exposure) the resist pattern on the glass sheet, is carried out by using an alignment mark formed simultaneously with the formation of the address electrode pattern; thus, it becomes possible to carry out a precise positioning process.

Next, by cutting off an unnecessary portion of the glass sheet 32 down to the bottom and removing the portion through sand blasting, the glass sheet 32 is formed into a shape of barrier ribs (see FIG. 3(a)). Here, alumina, zirconia, calcium carbonate, metal or the like may be used as an abrasive material. At this time, since the dry film 31 of the dielectric material has a sufficient elasticity, it is not cut off by the abrasive material for sand blasting, and serves as a stopper layer (electrode barrier layer).

### Dry Film Firing Process

After the cutting process by sand blasting, the substrate 21 on the back face side is put into a firing furnace, and the dry film 31 is fired at a temperature above the softening temperature of the low-melting-point glass contained in the dry film 31 of the dielectric material, as well as below the glass transition temperature of the glass sheet 32, so that the glass sheet 32 is anchored onto the softened dry film 31. At this time, since the glass sheet 32 is allowed to go down into the dry film 31 by its own weight of the glass sheet 32, it is possible to obtain a sufficient adherence strength.

In this case, in order to control the height of finished barrier ribs, a load G may be imposed onto the glass sheet 32 (see FIG. 3(b)). That is, the height of the barrier ribs is controlled by the size of the load G. For example, by increasing the load G, lower barrier ribs can be formed, and by reducing the load G, higher barrier ribs can be formed.

With respect to the forming method for the barrier ribs, the following method may be adopted. In the dry film forming process, the dry film may be formed by affixing a green sheet, as described above, and in this case, by adjusting the amount of resin in the green sheet to provide stickiness, the affixing process to the substrate can be carried out more easily. This green sheet may be wound into a roll shape, and stored, and upon application, this may be drawn out from the roll, and used.

The dry film 31 of the dielectric material may be formed by using a low-melting-point glass paste that exerts no stickiness when dried. In this case, after the low-melting-point glass paste has been applied by using a screen-printing method or a paste-coating method, a resin having an adhesive property may be sprayed thereon after the paste has been dried. That is, an adhesive, which contains a resin having an adhesive property of the amount, which is sufficient to allow the dry film to have an adhesive property to the glass sheet and such an elastic property as to withstand the sand blasting abrasive material, is discharged by a spray.

In the glass sheet securing process, in general, in an attempt to improve the contrast of the screen, a method in which top portions of the barrier ribs are colored in black is adopted, and when such a process is required, a glass sheet colored in black may be used.

Alternatively, with respect to the method for making the top portions of the barrier ribs black-colored, after the glass sheet has been secured onto the dry film, a black paste may be applied thereto by using a screen-printing method or a paste-coating method prior to the formation of a resist film so that, after the drying process, the resist film may be formed.

Moreover, with respect to the method for making the top portions of the barrier ribs black-colored, a black paste may be applied by using a screen-printing method onto a glass sheet from which the resist film has been separated after the sand blasting process, and after the drying process, the black paste dry film may be fired simultaneously with the firing process of the dry film of the dielectric material.

In the resist-film forming process, the film is formed by affixing a dry film resist onto the glass sheet 32; however, the resist film may be formed by applying a liquid-state resist to the glass sheet 32 to be dried thereon.

With respect to the resist pattern of the barrier ribs to be formed in this process, not particularly limited, any pattern may be used. For example, a stripe-shaped pattern may be used, or closed-state barrier-rib shape, such as a box shape, a delta shape, or another shape other than a straight shape, may be used.

After the sand blasting process, the removing process of the residual resist film on the glass sheet may be carried out by using an adhesive roller. Alternatively, this may be burned and eliminated simultaneously with the firing process of the dry film.

In this manner, by using a glass sheet as the barrier ribs, it becomes possible to eliminate the firing process of the barrier ribs, and consequently to prevent the end portions of each barrier rib from deflecting upward due to contraction upon firing the barrier ribs, thereby making it possible to prevent a noise generation from the panel caused by the deflection. Moreover, since the upper face of the glass sheet, as it is, forms the top portions of barrier ribs, the smoothness of the top portions of barrier ribs is improved so that the adhesion to the substrate on the front face side is improved. As a result, it becomes possible to make discharge coupling to adjacent cells (crosstalk) hardly occur, and consequently to obtain sufficient panel reliability. Furthermore, since no low-melting-point glass paste is required, the material cost of the barrier ribs can be reduced. Therefore, even in a case where, for example, closed-type barrier ribs such as those of a box type are formed, electrodes can be easily formed because the electrodes are preliminarily formed on the substrate prior to the formation of a dry film, thereby making it possible to solve the conventional major problem caused upon forming barrier ribs by directly cutting the glass substrate off.

Here, upon cutting the glass sheet, in addition to the above-mentioned sand blasting, a laser fine cutting process and a chemical etching process by the use of a chemical solution may also be adopted.

1. A method for forming barrier ribs of a plasma display panel comprising the steps of:
forming on a substrate a dry film which is fired to be formed into a dielectric layer;
securing on the dry film a glass sheet having a thickness corresponding to a height of barrier ribs to be formed;
forming a resist pattern corresponding to a shape of barrier ribs on the glass sheet so that, by cutting off the glass sheet corresponding to unnecessary portions through sand blasting, the glass sheet is formed into the shape of barrier ribs; and
firing the dry film at a temperature lower than the softening points of the substrate and the glass sheet so that the substrate and the glass sheet are anchored by the dielectric layer corresponding to the fired dry film.

2. The method for forming barrier ribs of a plasma display panel according to claim 1, wherein the dry film is formed by applying a paste-state dielectric material to a substrate to be dried thereon, with the paste-state dielectric material being prepared as a material that contains a sufficient amount of resin capable of providing adhesive property and sandblast resistance to the glass sheet after the drying process.

3. The method for forming barrier ribs of a plasma display panel according to claim 2, wherein the step of applying a paste-state dielectric material to the substrate is carried out by a screen-printing method.

4. The method for forming barrier ribs of a plasma display panel according to claim 2, wherein the step of applying a paste-state dielectric material to the substrate is carried out by a paste-coating method.

5. The method for forming barrier ribs of a plasma display panel according to claim 1, wherein the dry film is formed by affixing an adhesive sheet onto a substrate, with the adhesive sheet being prepared as a preliminarily formed adhesive sheet that contains a sufficient amount of resin capable of providing adhesive property and sandblast resistance to the glass sheet.

6. The method for forming barrier ribs of a plasma display panel according to claim 1, wherein the dry film is formed by spraying an adhesive agent over a paste dried film formed by applying a paste-state dielectric material onto a substrate to be dried thereon, with the adhesive agent being allowed to contain a sufficient amount of resin capable of providing adhesive property and sandblast resistance to the glass sheet.

7. The method for forming barrier ribs of a plasma display panel according to claim 1, wherein the glass sheet is prepared as a colored glass sheet.

8. The method for forming barrier ribs of a plasma display panel according to claim 1, further comprising the step of:
after the glass sheet has been secured onto the dry film, prior to the formation of a resist pattern on the glass sheet, applying a black paste onto the glass sheet to be dried thereon.

9. The method for forming barrier ribs of a plasma display panel according to claim 1, further comprising the step of:
upon firing the dry film, pressing the glass sheet onto the substrate side so that an adhesive property between the substrate and the glass sheet is improved.

10. A method for forming barrier ribs of a plasma display panel comprising the steps of:
forming a dry film that is fired to be formed into a dielectric layer on a substrate;
securing a glass sheet having a thickness corresponding to a height of barrier ribs to be formed on the dry film;
forming a resist pattern corresponding to a shape of barrier ribs on the glass sheet so that, by removing unnecessary portions of the glass sheet, the glass sheet is formed into the shape of barrier ribs; and
firing the dry film at a temperature lower than softening points of the substrate and the glass sheet so that the substrate and the glass sheet are anchored by the dielectric layer corresponding to the fired dry film.

11. A plasma display panel having barrier ribs, in which the barrier ribs are formed by the method for manufacturing barrier ribs of a plasma display panel according to any one of claims 1 to 10.
